(19) United States
(12) Patent Application Publication
(10) Pub. No.: US 2009/0063474 A1
(43) Pub. Date: Mar. 5, 2009

(54) System and Method for Information Retrieval

(76) Inventors: Stephen K. Curry, Ajax (CA); Oles Tymoshenko, Ajax (CA)

Correspondence Address: BERESKIN AND PARR, 40 KING STREET WEST, BOX 401, TORONTO, ON, M5H 3Y2, CA

(21) Appl. No.: 12/202,751

(22) Filed: Sep. 2, 2008

Related U.S. Application Data
(63) Continuation of application No. PCT/CA2007/000319, filed on Mar. 1, 2007.
(60) Provisional application No. 60/777,509, filed on Mar. 1, 2006.

(51) Int. Cl. G06F 17/30; G06F 15/16

(52) U.S. Cl. 707/5; 707/3; 707/10; 709/206; 707/E17.014; 707/E17.032; 707/E17.109; 707/E17.107

(57) ABSTRACT

A method of performing a search of an online directory, comprising receiving an identifier entered as part of website address; extracting the identifier entered as part of the website address; searching one or more databases associated with the online directory for instances of the identifier; and displaying information extracted from the one or more databases if a match was found for the identifier.

This application is a continuation of PCT/CA2007/000319 filed on Mar. 1, 2007 which claims the benefit of U.S. Provisional Application No. 60/777,509 filed Mar. 1, 2006. The disclosures of PCT/CA2007/000319 and 60/777,509 are incorporated herein, in their entirety, by this reference to them.

### FIELD OF THE INVENTIONS

The invention relates generally to the field of information retrieval. More specifically, the invention relates to a system and method for information retrieval from online directories.

### BACKGROUND OF THE INVENTION

With the increasing proliferation of communication devices and methods to access the Internet, a growing number of people make use of the Internet on a daily basis. Recent statistics indicate that close to 900,000,000 people had Internet access in 2005. According to some estimates, this represents a 146% increase from 2000. As a result, the Internet has become an indispensable tool for those who wish to search for information

As a greater number of people use the Internet, the demand for informational services such as phone directories (i.e. white and yellow pages) that are available online is growing.

There are currently many services available on the Internet that provide residential and business listing information. These listings are similar to what may be found in the paper versions of white pages and yellow pages type listings, respectively. These services allow users to search for information related to individuals, businesses or other entities. Information related to individuals may be located by searching for some combination of their name and address. Information related to businesses will primarily consist of the business name, address, and telephone number, and may be searched by entering some combination of the business name and geographic information pertaining to the business.

When searching for residential or business listings, various searching mechanisms are available. For example, a user who requires a listing of businesses that belong to a certain classification (i.e. restaurants, or contractors), may use a classification search by specifying the business classification and the geographic area of interest. When the user is in possession of unique information that can identify the business or individual, such as a telephone number, the user will first need to determine the business or individual name associated with the telephone number. Upon determining the name of the individual or business to which the telephone number relates, a search is then conducted based on the name.

Various “reverse lookup” services are available on the Internet that provide the user with the names of individuals or businesses associated with a specific telephone number. A user who knows the telephone number that is associated with a business or individual and requires more information will first need to make use of a service that provides reverse lookup functionality. The user then searches for more information based on the name that the reverse lookup returns.

The entering of searchable information into search fields is prone to error. Further, requiring the user to perform multiple searches to perform a “reverse lookup”, by making use of multiple search fields is inefficient.

### SUMMARY OF THE INVENTION

At least one embodiment described herein provides, a method of performing a search of an online directory, comprising receiving an identifier entered as part of a website address; extracting the identifier entered as part of the website address; searching one or more databases associated with the online directory for instances of the identification information; and displaying information extracted from the one or more databases if a match was found for the identifier.

At least one embodiment described herein provides, a method of performing a search of an online directory, comprising receiving an email message that comprises an identifier; extracting the identifier; searching one or more databases associated with the online directory for instances of the identification information; and providing information extracted from the one or more databases if a match was found for the identifier.

### BRIEF DESCRIPTION OF THE DRAWINGS

For a better understanding of the invention and to show more clearly how it may be carried into effect, reference will now be made, by way of example only, to the accompanying drawings which show at least one exemplary embodiment of the invention and in which:

FIG. 1 is a block diagram of the components of the information retrieval system;

FIG. 2 is an illustration of the fields of a residential listings database;

FIG. 3 is an illustration of the fields of a business listings database;

FIG. 4 is a block diagram illustrating the components of the directory application;

FIG. 5 is a flowchart of the steps of an embodiment of an information retrieval method;

FIG. 6 is an illustration of a listing display window;

FIG. 7 is a flowchart of the steps of an alternative embodiment of the information retrieval method;

FIG. 8 is an illustration of an email generated by the server in response to an Information request;

FIG. 9 is an illustration of the fields of a template database;

FIG. 10 is an illustration of an exemplary embodiment of a website template;

FIG. 11 is a flowchart of the steps of a website generation method; and

FIG. 12 is a flowchart of the steps of a website publishing and retrieval method.

### DETAILED DESCRIPTION OF THE INVENTION

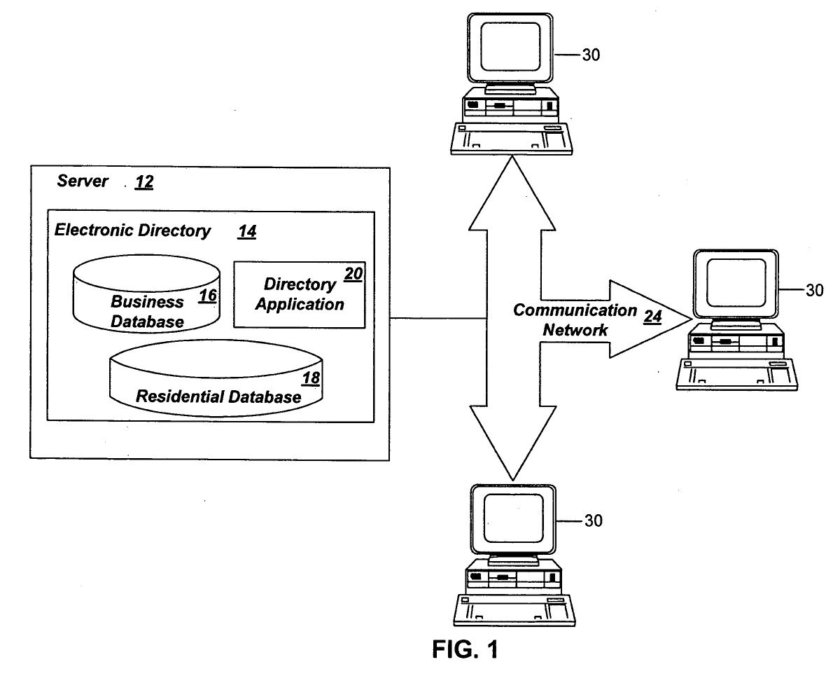

Reference is made to FIG. 1, where the components of an information retrieval system 10 in an exemplary embodiment of the invention are shown. The system 10 is comprised of a server computer 12, which has resident upon it, or has access to, an online directory 14. The online directory 14, in one exemplary embodiment, is further comprised of a residential listings database 16 and a business listings database 18. The server 12 is a computing device comprising a processor, memory store and means for connectivity to a network. The online directory 14 is accessible to the server 12, and in one embodiment is stored upon the server 12. The online directory 14 comprises, in one exemplary embodiment, one or more residential and business databases which contain information similar to “white pages” and “yellow pages” type listings respectively. The business database 18 is used to store information pertaining to businesses, that is similar to information that would appear in a “yellow pages” listing, and is illustrated in further detail below. The residential database 16 is used to store residential listings information, that is similar to information that would appear in a “white pages” type listing, and is illustrated in further detail below. The directory application 20, is a software application that is used to receive requests and process requests for information from the online directory 14, and is described in further detail below.

The electronic directory 14 is described above with reference to a residential database 16 and a business database 18. It should be understood, however, that the electronic directory 14 may store or have access to databases that relate to various entities, including but not limited to, governmental agencies, not for profit agencies, charities, and any other such entities.

The system 10 allows for one or more communication devices 30 to communicate with the online directory 12 through a communication network 24. The communication network 24 may be any type of network that allows for the exchange of data. The communication network 24 that is described herein, generally refers to the Internet. The communication network 24 may also be a network that allows for connectivity between communication devices 30 via wired or wireless means, which may include but is not limited to a wide area network, a local area network, and the Intranet.

Examples of communication devices 30 include, but are not limited to, personal desktop computers, work-station computers, server computers, laptops, mobile/handheld computers, wireless e-mail devices, or any other such device that can communicate with the system 10 through the communication network 24. The communication device 30 includes an interface (not shown) and an input means (not shown), which allow for the communication devices 30 to interact with the system 10.

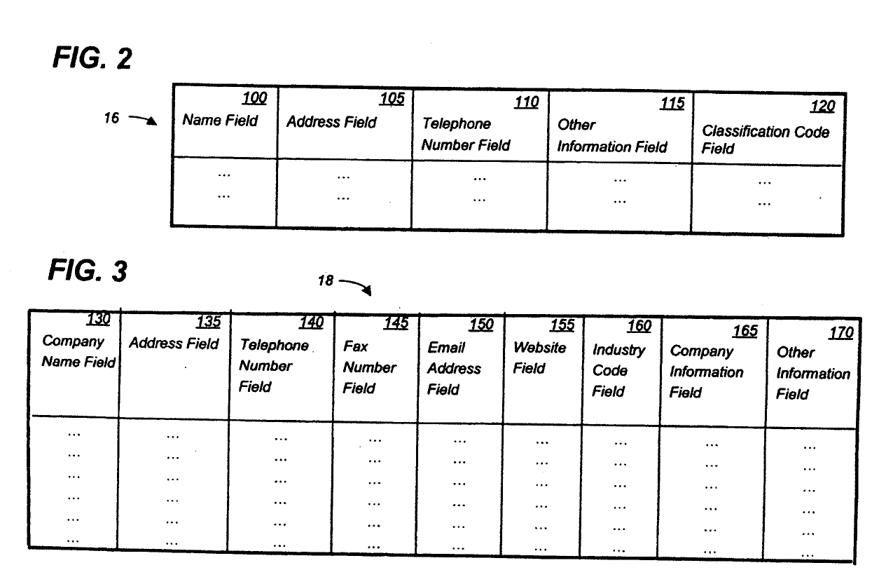

Reference is now made to FIG. 2, where the fields of the residential listings database 16, are shown in one embodiment. The following table is used to Illustrate the fields of the residential listings database 16 in one exemplary embodiment.

| Field | Description |
|---|---|
| Name Field 100 | Contains, where applicable, the first, |
| | middle and last name of the |
| | individual(s) who are associated with |
| | this listing. |
| Address Field 105 | Contains, where applicable, the |
| | address including the street name, |
| | number, city, county, state/province, |
| | zip/postal code, and country. |
| Telephone Number Field 110 | Contains the country code, area code |
| | and phone number associated with |
| | the particular listing. |
| Other Information Field 115 | May contain any additional |
| | information pertaining to this |
| | particular listing, including, but not |
| | limited to, information such as the |
| | email address of individuals at this |
| | address. |
| Classification Code 120 | May contain a reference to a |
| | classification mechanism used to |
| | classify residential listings. |

Reference is now made to FIG. 3, where the fields of the business listings database 18, in one exemplary embodiment, are shown below:

| Field | Description |
|---|---|
| Company Name Field 130 | The business name associated with |
| | the listing. |
| Address Field 135 | Contains the address of the place of |
| | business, including, where applicable, |
| | the street number, name, city, county, |
| | province/state, zip/postal code, |
| | country. |
| Telephone Number Field 140 | The telephone number associated |
| | with the business. |
| Fax Number Field 145 | The fax number, if any, associated |
| | with the business. |
| Email Address Field 150 | The email address, if any, associated |
| | with the business. |
| Website Field 155 | The website, if any, associated with |
| | the business. |
| Classification Code Field 160 | Industrial classification code |
| | describing the products or services |
| | associated with the business. |
| Company Information Field 165 | A description of the products and |
| | services associated with the |
| | business. |
| Other Information Field 170 | May store any other information with |
| | respect to this particular listing (i.e. |
| | history of the company). |

The business listings database 18, as described above, includes fields that may be optional in an exemplary embodiment, and fields that are required in the system 10. Optional fields include, in one embodiment, the fax number field 145, the email address field 150, the website field 155, the company information field 165 and the other information field 170.

The residential listings database 16 and the business listings database 18 may be compiled through various methods, including manual compilation where information is taken from various sources and entered into the respective database. The respective databases 16 and 18 may also be compiled through user interaction where the user specifies the information that is to be included as part of the listing. In one embodiment, users may be given the option of editing and updating information contained in the database.

The data contained in the classification fields may be used to classify entries in the databases based on various classification systems that may be employed. For example, the classification code associated with residential listings may classify listings geographically, and the classification code associated with the business listings may classify entries in the database according to the field of business to which the entries relate.

In one embodiment, the data contained in the industry code field 160 may be based on one or more standardized business activity classification systems. For example, one such business classification system is the Standard Industrial Classification (SIC), which has been developed to classify businesses by the type of activity they are engaged in. The SIC was designed to cover the entire field of business activities by defining industries in accordance with the composition and structure of the economy. The SIC employs a four digit code that is used to represent the primary activity that a business is engaged in. Recently, due to changes in the economy, other business classification systems have been introduced to deal with the increasing number of areas or sectors that a business may be engaged in. For example, the North American Industry Classification System (NAICS) uses a six-digit code that allows for classifications to be assigned for businesses that are taking part in newer industries. It should be understood that SIC and NAICS are only two examples of industry classification systems that may be used, as any classification system that allows for entries to be grouped by category may be used. Therefore, the classification code field 160 comprises codes used to classify the business sector to which the business relates. The operator of the system 10, may define and use its own classification code system or any other classification method.

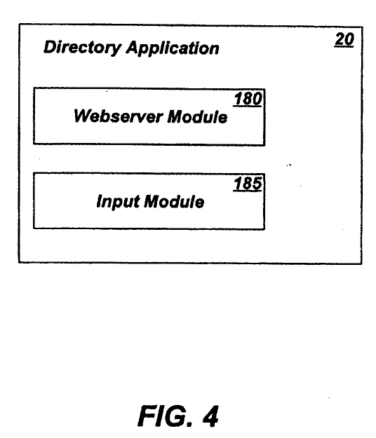

Reference is now made to FIG. 4, where components of the directory application 20 are shown in an exemplary embodiment. The directory application 20, in one embodiment, is comprised of a webserver module 180, and an input module 185. The web server module 180 is a software application that is used to publish information on the Internet in an exemplary embodiment. It should be noted that the web server module 180 may be resident upon an independent computing device, and has been shown as resident upon the server 12 for purposes of example only. The input module 185 is used to receive and process requests received at the server 12.

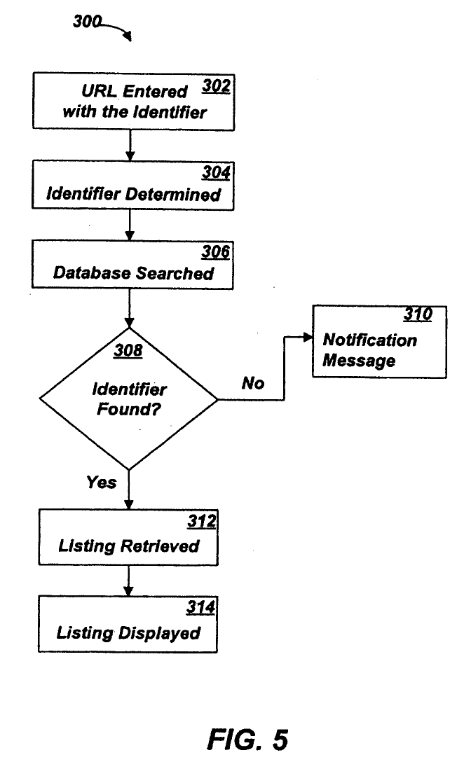

Reference is now made to FIG. 5, where steps of an information retrieval method 300 are shown in an exemplary embodiment. Information retrieval method 300 is engaged by a user or system when information pertaining to a specific individual or business is required. Information retrieval method 300 does not require the user to make use of search fields located upon a website, or enter multiple pieces of information when searching for information.

In this embodiment, method 300 is invoked through a user accessing a specified URL. Method 300 begins at step 302, where the user engages the system 10 to search for information related to a specific individual or business. The user who engages the information retrieval method 300, to search for information related to an individual or business, is in possession of an identifier that can be used to identify the particular individual or business. Examples of such identifiers may include, but are not limited to, telephone numbers, fax numbers, email addresses and names associated with a residential or business listing. At step 302, the user enters a URL. The URL associated with the information retrieval method 300 may have any top level domain (i.e. .com, .net, ca, .biz, or any other such domains), and for purposes of example is illustrated with reference to the domain, www.domain.com. At step 302, the user will enter the identifier as part of the URL associated with the domain. The identifier may be entered as associated with the URL through various methods. For example, if the identifier is the telephone number (i.e. area code 222, and phone number 555-1212), the user may engage information retrieval method 300 by entering www.domain.com/2225551212 as the URL. Alternatively, the identifiers may also be entered as www.222-555-1212.domain.com or http://222.555.1212.domain.com, or through any other similar connections.

Upon the user entering the URL, also referred to as a website address with the identifier, method 300 then proceeds to step 304. At step 304, the identifier that is entered as part of the URL is parsed.

Method 300 then proceeds to step 306, where based on the identifier entered at step 302, the various databases accessible to the electronic directory 14 are searched to determine instances of the identifier.

Method 300 then proceeds to step 308, where a check is performed to determine whether the identifier is found in the search conducted at step 306. If the identifier is found at step 306, method 300 proceeds to step 312. If the identifier is not found at step 306, method 300 proceeds to step 310.

At step 310, a notification message is displayed to the user upon the website, indicating that no listing is found for the identification information that has been provided. In one embodiment, if an exact match is not found for the identifier, but similar identifiers were located, a listing of the records containing those identifiers will be displayed upon the website.

If the identifier is found at step 306, method 300 proceeds to step 312, where the listing information is retrieved for display upon the website.

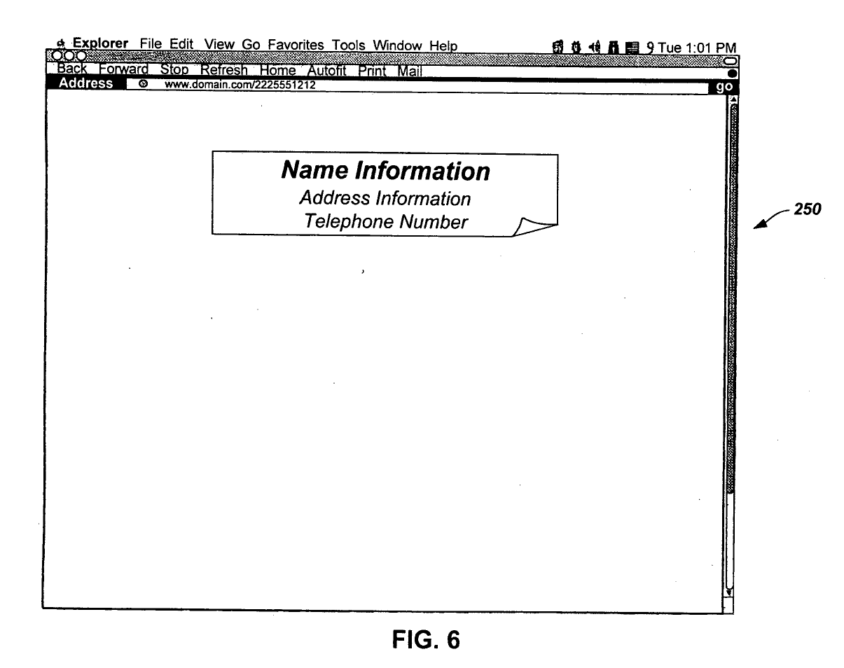

Method 300 then proceeds to step 314, where the listing is displayed upon the site. Reference is made to FIG. 6, where one embodiment of a listing display window 250 is shown. The listing display window 250 is created by the web server module 180 and displays the listing information associated with the user specified identifier that is located at step 306. The information may be displayed as a listing of information as is shown in FIG. 6.

Method 300 therefore allows a user to search for information that relates to a specific name or telephone number by entering only an identifier as part of the URL.

In an alternative embodiment, the information retrieval method may be engaged through use of communication devices 30 other than computing devices. The information retrieval method 300, in alternative embodiments, may be engaged by means of telephone communication, wireless devices, email, and other such suitable means. The information retrieval method 300 has been described with respect to an identifier being entered as part of URL on a website. In alternative embodiments, identifiers may be received by the system 10 through various methods, including as part of an email message received by the server, or though alphanumeric entry of the identifier upon through a phone service. In one embodiment, the user may provide the identifier as part of the subject line in an email. In such an embodiment, the email address is associated with the system 10, and the system 10 receives any emails sent to that address. Alternatively, the information retrieval method 300 may use a phone device as a communication device 30, where the user enters identifier information (either through voice or alphanumeric entry), and that information is received by the system 10.

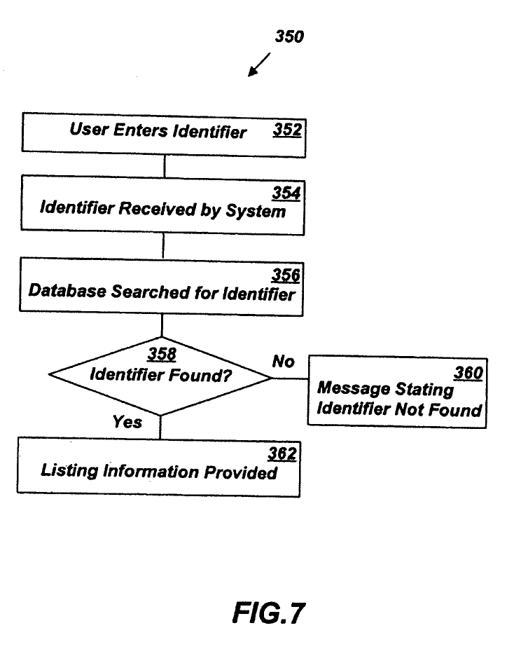

Reference is now made to FIG. 7, where an alternative embodiment of the information retrieval method is shown generally as 350. Method 350 is illustrated with respect to the use of email that is sent to the server 12. The email may be sent from personal desktop computers, wireless hand held devices, cell phones, or any other such means by which emails may be composed and transmitted. The email may originate from any email address. The email will be sent to an email address associated with the server, where the email address is dedicated, such that it is used for information requests. As an example, the system 10 may employ a dedicated email address such as informationrequest@domain.com, which may be used to engage the information retrieval system 10. Method 350 begins at step 352 where the user provides the identifier. At step 352, the user may provide the identifier as part of the subject line, or as part of the body of the message. If the user provides the identifier as part of the body, the identifier may be the only information found in the body, or may be associated with a special tag used in the body of the message that will allow for the identifier to be identified as such.

Method 350 then proceeds to step 354 where the email is received by the server 12. The email contains an identifier which is determined at step 354. Once the identifier has been determined at step 354, method 350 proceeds to step 356. At step 356, the databases accessible to the server 12 are searched to determine if instances of the identifier may be found. Method 350 then proceeds to step 358, where a check is performed to determine whether the identifier has been located. If the check performed at step 358 determines that the identifier is not found, method 350 then proceeds to step 360. At step 360, the user is informed that the identifier could not be located. The message of step 360 is provided to the user as an email message indicating that no information related to the identifier could be located. If the search conducted at step 356 did not result in an exact match, but rather resulted in matches that were similar to the identifier provided, these partial matches may also be provided to the user in the form of an email.

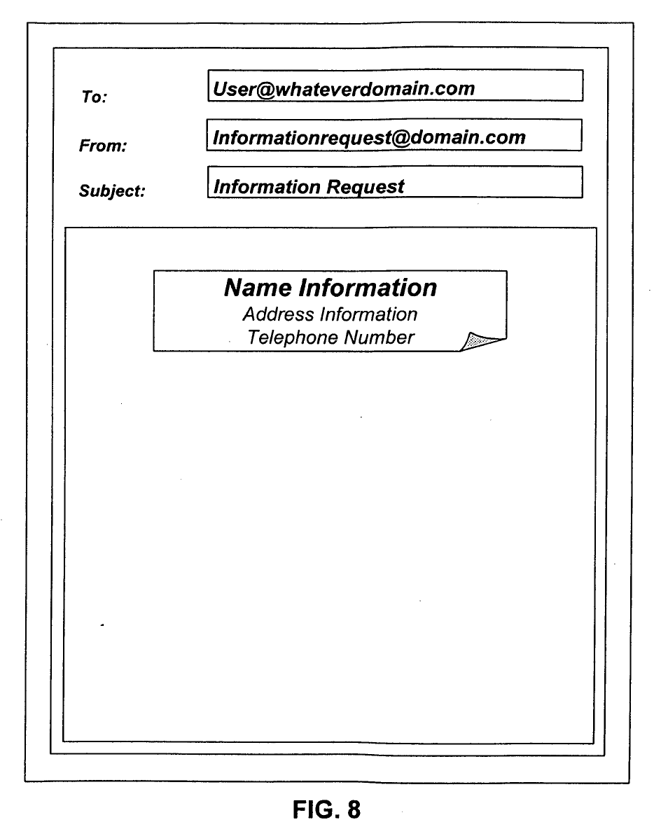

If at step 358, it is determined that the identifier has been found, the listing information associated with the entry is extracted from the respective database, and is provided to the user. The user receives the listing information associated with the identifier at step 362. At step 362, the listing information associated with the identifier is provided to the user in the form of an email, where the body of the message contains the listing information. Reference is made to FIG. 8, where an email message that is sent to the user in response to a user request is shown.

In another embodiment of the system 10, the listing information that is found may be presented to the user in the form of a customized automatically generated website. The customized automatically generated website is customized based on the classification that is associated with the listing. The customized website may be generated for either business or residential listings. While customized websites may be created for displaying information that has been requested for individuals (i.e. may be customized by geographic information, or may display points of interest in proximity to the individual's address), the customized websites in this embodiment are described with respect to customized websites that are created for business listings.

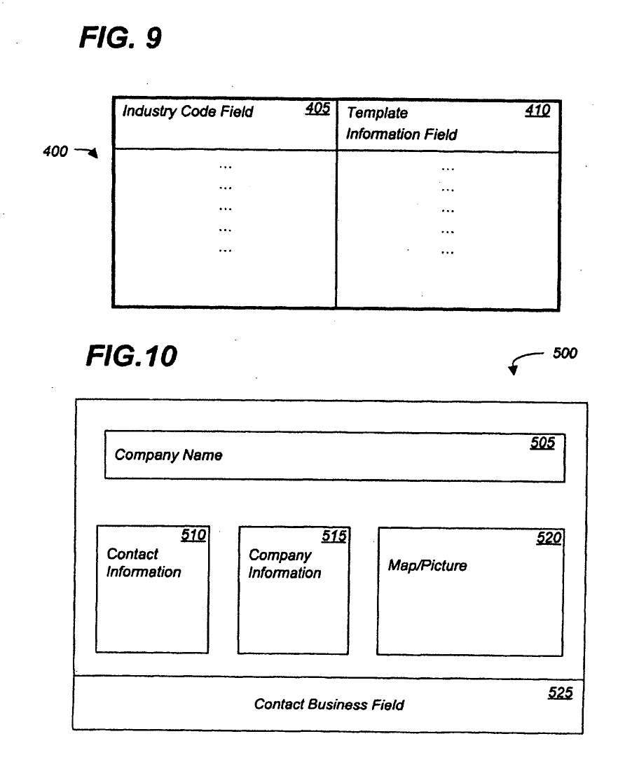

Reference is now made to FIG. 9, where the fields of an exemplary embodiment of a template reference database 400 are shown. In one embodiment, the template reference database 400 contains an industry code field 405 and a template information field 410. The industry code field 405 contains a listing of all the codes that are associated with the particular industry classification system, which is employed in the system 10. The template information field 410 for each entry in the industry code field 405, contains a reference to one or more website templates. In an exemplary embodiment of the system 10, one or more website templates are defined. The website templates correspond to different websites which may be generated. The websites may include, but are not limited to, text, fields, graphics and/or images, formulas, scripts, HTML code, Java Script, Flash Pages and Flash Animation and any other functionality. One or more websites templates may be designed for each industry code that is employed in the industry classification system, or one website template may be associated with more than one industry code. The website templates are designed to relate to the particular industry code that they correspond with. For example, website templates may have associated with them graphics or pictures that relate to the particular class of goods and or services associated with the particular industry code. In the system 10, website templates are customized for the various industry classification codes that are employed.

Reference is now made to FIG. 10, where an exemplary embodiment of a website template 500 is shown. The website template may be comprised of one or more web pages. In FIG. 10, a one page website template 500 is shown, which is comprised of a company name field 505, a contact information field 510, a company information field 515, a map/picture field 520 and a contact business field 525.

The company name field 505 allows the business name to be displayed on the website. The contact information field 510 may contain, if applicable, the following information: the address of the business, the telephone number, e-mail address, website address. The company information field, where applicable, will be comprised of other information pertaining to the business, including, where applicable, the general category of goods and/or services that are offered. The map/picture field 520 may be used for either pictures/graphics that are associated with the business, or for a map may be generated with respect to the co-ordinates of the business. The contact business field 525 may contain automated scripts by which the user may click on appropriate functionality and request additional information from the business and send an email to the business.

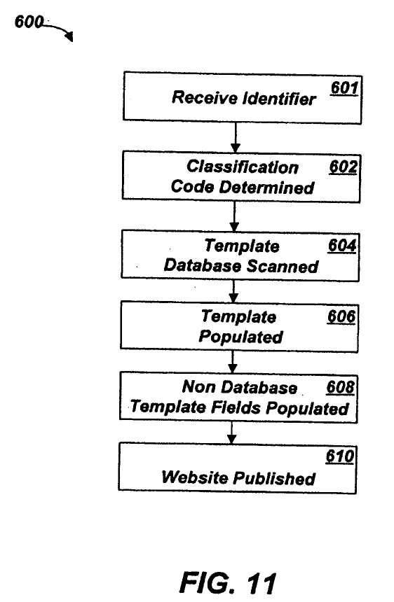

Reference is now made to FIG. 11, where the steps of a website creation method 600, in one exemplary embodiment are shown. The website creation method 600 is used to generate customized websites to display information contained in the respective databases. The customized website creation method may be used to generate websites for business or residential listings, or for listings related to other entities. The website creation method 600 is described here for purposes of example with respect to the generation of websites for business listings.

At step 601, the method receives the identifier that is associated with the listing for which a website is to be generated. At step 602, the business database 18 is accessed to determine the industry code that is associated with the particular listing.

Method 600 then proceeds to step 604, where the industry code associated with the particular entry is used to search the template database 400. The template database specifies for each industry code used in the particular industrial classification system, a website template that is to be used when generating a website. The template database 400 is searched at this step to determine the appropriate template that is to be used, as indicated by information provided in the template information field 405.

Method 600 then proceeds to step 606, wherein the template is populated, based on information contained in the appropriate database, which in this embodiment of the invention is the business database 18. The data required to populate the fields of the template is extracted from the business database 18. Based on the fields contained in the specific template that is being employed, data is retrieved from the business database 18. Upon the population of all the template fields that require information from the business database 18 (i.e. the business name, the address field, the contact information, the company information field), method 600 may proceed to optional step 608.

Method 600 may then proceed to step 608, if there remain template fields to be populated that require information that may not be directly extractable from the business database 18. Step 608 is used to populate template fields that do not require further information directly from the respective databases, such as the automatic generation of a map (based on co-ordinate information found in the business database), or a counter mechanism which tracks the number of hits on a website. A map may be generated by making use of the address as found in the business database 18, and providing that information to a map creation service. Upon the completion of optional step 608, or step 606 if step 608 has not been required, a website will have been generated. The website will have been generated and will display to the user all the information that is contained with respect to the listing associated with the specified identifier.

Method 600 then proceeds to step 610, where the website that has been generated is published on the Internet through the webserver module 180. The websites that have been generated are customized according to the business to which they relate, by having predefined graphics, or pictures that are relevant to that particular class of business.

Method 600 has been described with respect to creating customized websites in response to a user request for information pertaining to businesses, however, it should be understood that the system 10 and the respective methods may be used to search for information pertaining to various entities, other than individuals and businesses. As an example, the respective databases may contain information pertaining to governmental services, or not for profit organizations or any other entities. The customized websites may be customized for entities other than businesses and may be customized for residential listings or any other listing information which is stored in the appropriate databases.

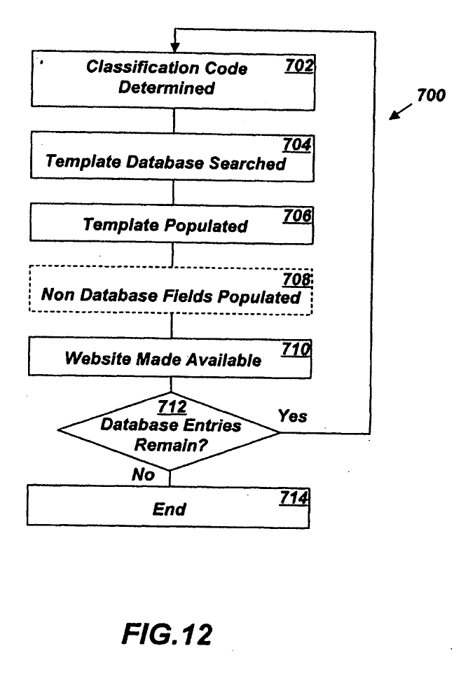

Reference is now made to FIG. 12, where the steps of an alternative embodiment of a customized website creation method are shown. The website creation method 600, as described in FIG. 11 creates a customized website after a user request has been received. In the alternative embodiment, as illustrated with reference to FIG. 12, the customized websites are created before a user request is made. As a result, the websites are created and published such that they are accessible to users before any requests are made by users. In the embodiment shown in FIG. 11, the websites are created only after a request has been made. Alternatively, as described in website creation method 700, the customized websites are created before any request is made by the user.

Method 700 begins at step 702, where, for each listing that is contained in the respective databases, a classification code is determined. Method 700 then proceeds to step 704 where the classification code that may be associated with each entry in the respective database is used to search the template database 400. The search of the template database will return the appropriate template that may be used to generate the website.

Method 700 then proceeds to step 706, where the template is populated based on information that is stored in the respective database. The data that is required in order to populate the fields of the template is found in the database, and the information is extracted based on the fields of the template. Once the template fields that require information from the respective database have been populated, method 700 proceeds to step 708.

Step 708 is used to populate template fields which may require information other than what is available from the respective databases. For example, a map may be generated, indicating the address. The map may be generated by making use of the address as found in the database, and then providing that information to a map creation service.

Method 700 then proceeds to step 710, where the website that has been generated is published on the Internet through the webserver module 180. Method 700 then proceeds to step 712. As each customized website is generated for entries found within the respective databases, the website will be published.

Method 700 then proceeds to step 712, where a check is performed to determine whether any database entries remain for which a customized website has not been generated. If check 712 determines that entries remain for which customized websites are to be generated, then method 700 returns to step 702 where the classification code for the next entry for which a customized website to be generated is determined.

Method 700 ends when customized websites have been generated for all entries in the respective databases. As entries are added to the respective databases, and as they may be deleted or edited, the customized websites are automatically updated to reflect that. For example, if the entry in the database is edited, the customized website is edited to reflect the change. If the entry is removed from the database then the corresponding customized website is removed such that it would not be available to anyone trying to access.

The present invention has been described with regard to preferred embodiments. However, it will be obvious to persons skilled in the art that a number of variants and modifications can be made without departing from the scope of the invention as described herein.

1. A method of performing a search of an online directory, comprising
a) receiving an identifier entered as part of a website address;
b) extracting the identifier entered as part of the website address;
c) searching one or more databases associated with the online directory for instances of the identifier; and
d) displaying information extracted from the one or more databases if a match was found for the identifier.

2. The method of claim 1, wherein the online directory comprises residential listings.

3. The method of claim 1, wherein the online directory comprises business listings.

4. The method of claim 1, wherein the identifier is a phone number.

5. The method of claim 1, wherein the identifier is an address.

6. The method of claim 1, wherein the identifier is component of an address.

7. The method of claim 1, wherein the identifier is an e-mail address.

8. A method of performing a search of an online directory, comprising
a) receiving an email message that comprises an identifier;
b) extracting the identifier;
c) searching one or more databases associated with the online directory for instances of the identifier; and
d) providing information extracted from the one or more databases if a match was found for the identifier.

9. The method of claim 8, wherein the identifier is provided in the subject line of an e-mail message.

10. The method of claim 8, wherein the identifier is provided in the body of an e-mail message.

11. The method of claim 8, wherein information is provided to a requester through an e-mail message.

12. The method of claim 8, wherein the online directory comprises residential listings.

13. The method of claim 8, wherein the online directory comprises business listings.

14. The method of claim 8, wherein the identifier is a phone number.

15. The method of claim 8, wherein the identifier is an address.

16. The method of claim 8, wherein the identifier is component of an address.

17. The method of claim 8, wherein the identifier is an e-mail address.
